(19) United States
(12) Patent Application Publication
(10) Pub. No.: US 2025/0215237 A1
(43) Pub. Date: Jul. 3, 2025

(54) AQUEOUS COMPOSITIONS CONTAINING ENCAPSULATED CORROSION INHIBITORS AND METHOD MAKING USE THEREOF

(71) Applicant: CHEMETALL GMBH, Frankfurt (DE)

(72) Inventors: Mubarik CHOWDHRY, Frankfurt (DE); Nawel Souad KHELFALLAH, Frankfurt (DE); Michael POHLING, Frankfurt (DE); Pierre-Eric MILLARD, Ludwigshafen (DE)

(21) Appl. No.: 18/848,168

(22) PCT Filed: Apr. 25, 2023
(86) PCT No.: PCT/EP23/60771

§ 371 Date: Sep. 18, 2024

(30) Foreign Application Priority Data
Apr. 26, 2022 (EP) 22170013.1

(51) Int. Cl. C09D 5/02; B01J 13/18; C08K 5/1545; C08K 5/47; C08K 9/10; C09D 5/08; C09D 7/40; C09D 7/61; C09D 7/63; C09D 133/12; C09D 175/00

(52) U.S. Cl. CPC C09D 5/024; B01J 13/18; C08K 5/1545; C08K 5/47; C08K 9/10; C09D 5/08; C09D 7/61; C09D 7/63; C09D 7/70; C09D 133/12; C09D 175/00; C08K 2201/005

(57) ABSTRACT

Described herein are an aqueous coating composition including capsules, which contain corrosion inhibiting compounds, a method of using the composition for corrosion protection of metallic substrates, a method for treatment of metallic substrates by using the coating composition, and coated substrates obtainable therefrom.

The present invention relates to an aqueous coating composition comprising capsules, which contain corrosion inhibiting compounds, a use of said composition for corrosion protection of metallic substrates, a method for treatment of metallic substrates by making use of said coating composition, and to coated substrates obtainable therefrom.

### BACKGROUND OF THE INVENTION

Nowadays metallic surfaces and particularly galvanized surfaces of substrates are treated with acidic Cr-free thin coating formulations, which form a thin permanent coating (PC) layer for corrosion protection, anti-fingerprint properties, water resistance and/or other properties such as paint adhesion on the surfaces of the substrates. Such permanent coating layers are usually transparent layers applied in a dry film thickness of about 1 to <2 μm. In particular, on steel surfaces such as surfaces made of galvanized steel the coating formulation applied is typically acidic and contains besides a polymer dispersion for film-forming abilities, inorganic constituents such as metal-fluoride complexes and formulation additives such as a defoamers and wetting additives. However, it is also possible to use respective alkaline coating formulations, in particular on aluminum-based or aluminum-containing substrate surfaces, which are usually formulated as 2K coating systems. A polymer dispersion alone is usually not sufficient to ensure a sufficient corrosion protection in each case. Therefore, aforementioned inorganic constituents are usually further added to fulfill in particular the industry's requirement of corrosion protection as these may react with the metallic surface to form a protective (conversion) layer on the surface. The combination of the aforementioned inorganic constituents with the polymer dispersion yields a uniform thin film covering the metallic surface homogeneously.

US 2012/0171402 A1 relates to a process for coating metallic surfaces by contacting the surfaces with an aqueous composition containing inter alia at least one organic film-forming ionomeric polymer or copolymer and a low temperature corrosion inhibiting cross-linking agent having a pH value of from 6 to 10.5 and being free of any wax and oil. US 2012/0171402 A1 aims at providing corrosion protecting coatings at temperatures below 80° C. PMT (peak-metal-temperature) at low costs.

US 2013/0177768A 1 discloses a method for coating of metallic surfaces, which includes a step of applying an aqueous composition having a pH value of 1 to 4 to said surface, said composition comprising inter alia inorganic constituents and a polymeric dispersion. US 2013/0177768A 1 aims at providing protecting layers on substrates formed from said composition, which exhibit a high resistance to moisture as well as a good corrosion resistance.

WO 2008/110480 A1 is directed at a process for coating a metallic surface with an aqueous composition comprising inter alia an organic film former, a long-chain alcohol as film-forming aid, an inorganic crosslinker, and a lubricant. WO 2008/110480 A1 aims inter alia at providing a process with a high coating speed and which makes of a composition not containing any chromium (VI) and which is as far as possible free from inorganic and organic acids.

WO 2016/154680 A1 discloses a method of protecting a substrate from corrosion comprising applying a corrosion inhibitor composition to a surface of said substrate, wherein the corrosion inhibitor composition comprises at least one metal salt or mixed metal salt, and at least one organic heterocyclic compound as corrosion inhibiting agent. WO 2016/154680 A1 aims at providing chromate-free corrosion inhibitor compositions offering good corrosion protection.

The conventional compositions disclosed in the prior art offer not always a sufficient corrosion protection and/or water resistance and/or adhesion to the substrate and/or to further layers applied thereon, and, further, are not always suitable to provide permanent coating (PC) layers, in particular when applied in comparably thin dry film thicknesses such as thicknesses of about only 1 μm or lower. In particular, often a substantial formation of white rust can be observed upon application of the conventional compositions on steel surfaces, said formation being outside the amount tolerable by the customer's requirements such as the requirements of the coil and appliance industry. The amount of white rust formed may be in some cases lowered by applying the compositions in higher dry film thicknesses of, e.g., up to or exceeding 2 μm. However, such higher dry film thicknesses are in turn again not acceptable due to customer's requirements regarding permanent coating layers for other reasons.

It is further known to include corrosion inhibiting agents into the conventional compositions disclosed in the prior art in order to further improve corrosion protection. However, the conventionally used corrosion inhibitors known in the prior art are often disadvantageous: for instance, a lot of known corrosion inhibitors conventionally used are labelled as being toxic such as chromium (VI) compounds. Also known are other hazardous or environmentally problematic constituents for corrosion protection such as inorganic pigments, e.g., phosphates, molybdates, and other inorganic complexes. The use of such corrosion inhibitors is, hence, undesired for ecological reasons, but also due to safety and health reasons with respect to the persons handling and working with these compounds.

Further, although a considerable number of corrosion inhibitors such as a variety of organic compounds is not necessarily toxic or hazardous—as it is the case for the inorganic compounds mentioned above, these compounds often are water-insoluble or essentially insoluble in water. While this may not be regarded as a problem for application of solvent-borne compositions, it certainly is disadvantageous for applications, where aqueous compositions are to be used and applied, since these kinds of corrosion inhibitors cannot be used and incorporated into such aqueous compositions usable for providing PC layers due to their low or non-existent solubility in water, hence, limiting their use in water-borne formulations.

Thus, there is a need to provide aqueous coating compositions suitable for providing thin permanent coating layers on substrates, which show at least the same, but preferably an improved, resistance to corrosion and/or water, substrate adhesion and adhesion to any layers applied on top, as conventionally used aqueous coating compositions, but which allow making use of conventional effective corrosion inhibiting agents, which as such are known to be not or essentially not soluble in water or have only a low water solubility.

### Problem

It has been therefore an objective underlying the present invention to provide aqueous coating compositions suitable for providing thin permanent coating layers on substrates, which show at least the same, but particularly an improved, resistance to corrosion and/or water, substrate adhesion and adhesion to any layers applied on top, as conventionally used aqueous coating compositions, but which allow making use of conventional effective particularly organic corrosion inhibiting agents, despite the fact that these are known to be as such not or essentially not soluble in water or have only a low water solubility.

### Solution

This objective has been solved by the subject-matter of the claims of the present application as well as by the preferred embodiments thereof disclosed in this specification, i.e., by the subject matter described herein.

A first subject-matter of the present invention is an aqueous coating composition comprising besides water
at least one film-forming polymer,
at least one metal ion selected from the group of titanium, zirconium and hafnium ions, and mixtures thereof, and
at least one encapsulation structure comprising a polymeric shell and a core within the shell, wherein
   the shell is obtainable from polymerization of at least one (meth)acrylic monomer or from a monomer mixture comprising the at least one (meth)acrylic monomer, in the presence of the core, and
   the core comprises at least one corrosion inhibiting constituent, said constituent having in its non-encapsulated state a water solubility at 23° C. of less than 50 g/L, wherein the core optionally further comprises at least one non-aqueous solvent.

The solubility in water is measured according to the method disclosed hereinafter in the ‘method’ section.

A further subject-matter of the present invention is a use of the inventive aqueous coating composition for corrosion protection of metallic substrates, in particular for and/or by releasing the corrosion inhibiting compound present within the shell of the encapsulation structure, which is present in the aqueous coating composition, preferably after having applied the aqueous coating composition at least in portion onto a surface of an optionally pre-coated metallic substrate to form a coating film at least in portion on said surface.

A further subject-matter of the present invention is a method for treatment of at least one surface of an optionally pre-coated metallic substrate comprising at least step 1) and optionally also step 2), namely
1) applying the inventive aqueous coating composition at least in portion onto the at least one surface of the metallic substrate to form a coating film at least in portion on said surface, and
2) optionally curing or drying the coating film obtained after step 1) to give a cured or dried coating layer, wherein the obtained cured or dried coating layer preferably has a dry film thickness below 2.0 μm.

A further subject-matter of the present invention is a metallic substrate comprising at least one surface, wherein said at least one surface has been treated according to the inventive treatment method.

It has been surprisingly found that corrosion inhibitors, which have a solubility in water of ≤5 g/L or, which are essentially insoluble or are insoluble in water, can be nonetheless used effectively as corrosion inhibitors in aqueous systems, in particular in aqueous acidic coating compositions, but also in respective alkaline coating compositions, in each case suitable to provide thin permanent coating (PC) layers on metallic substrates, when they are—prior to incorporating them into these aqueous systems—encapsulated into an encapsulation structure as a core of said structure, said core being surrounded by or embedded in a polymeric shell, which is at least partially formed from (meth)acrylic monomers. It has been further found that it is possible and advantageous to prepare a shell bearing monomeric units comprising functional groups such as OH-groups and/or COOH-groups and/or sulfur atom(s) containing groups such as thioether groups and/or phosphorous atom(s) containing groups such as phosphonic acid groups. Such functional groups may further act as anchors to the metallic surface, when the encapsulation structure is incorporated into an aqueous composition, which is in turn applied onto a metallic surface for providing a permanent coating layer, for complexation of the inorganic constituents present therein such as H₂TiF₆ and/or H₂ZrF₆ and/or Zr- and/or Ti-complexes, which are free of fluoride, and for improving adhesion to any further coating films applied on top of the PC layer, e.g., by formation of covalent bonds. In addition, the presence of functional groups such as COOH-groups and/or sulfur atom(s) containing groups in the shell may lead to a further increase not only in the corrosion protection performance, but may also improve the stability of the coating composition and/or allow a better interaction with the metallic surface once the composition is applied.

It has been in particular surprisingly found that an aqueous coating composition containing at least one encapsulation structure is suitable to be used as a permanent coating composition, which in turn can be used to provide a permanent coating layer onto a surface of a substrate, in particular onto a metallic surface such as a steel including galvanized steel surface. It has been in particular found that the encapsulation structure is very stable in acidic medium.

Further, it has been in particular surprisingly found that permanent coating layers obtained from the aqueous coating composition comprising the encapsulation structure exhibit an excellent corrosion protection and/or water/humidity resistance when present onto a metallic surface such as a surface made of steel, even when applied in dry film thicknesses below 1.5 μm such as below 1.3 μm. In particular, no significant or even no formation of white rust at all is observed in this case. It has been found that encapsulated corrosion inhibitors such as encapsulated benzothiazole and/or quercitin boosts the corrosion protection of in particular Cr-free PC layers on steel, in particular galvanized steel such as HDG (hot dip galvanized steel). Similar effects can be observed, when a respective aqueous alkaline coating composition is used, in particular on aluminum-based or aluminum-containing substrate surfaces such as Galvalume®. An additional advantage of using such an aqueous alkaline coating composition containing an inventively used encapsulation structure is that such a composition can be used as a 1K-composition and that the use of, e.g., organosilanes conventionally used as corrosion inhibitors in alkaline compositions, which have to added/stored in form of a separate component and thus requiring making use of a 2K-coating system, can be avoided.

Additionally, it has been in particular surprisingly found that permanent coating layers obtained from the aqueous coating composition comprising the encapsulation structure exhibit an excellent paint adhesion in case any further coating film such as a powder coating film is applied on top of it, even when the PC layers are applied in dry film thicknesses below 1.5 μm such as below 1.3 μm.

Moreover, it has been found that the aqueous coating composition does not exhibit any compatibility issues with respect to its constituents, in particular with respect to the inorganic constituents, the encapsulation structure present therein and the at least one film-forming polymer, in particular when at least two different film-forming polymers are used such as, e.g., at least one (meth)acrylic polymer or copolymer and at least one polyurethane. In particular, no undesired precipitation of the at least one film-forming polymer is observed. Furthermore, in case at least two different film-forming polymers are used such as, e.g., at least one (meth)acrylic polymer or copolymer and at least one polyurethane, no stability issues attributed to the pH value of the composition and any stabilizing groups of the polymers are observed.

In addition, it has been found that in case aqueous coating compositions are used, which contain at least two different film-forming polymers such as, e.g., at least one (meth)acrylic polymer or copolymer and at least one polyurethane, the incorporation of the encapsulation structure allows an at least partial replacement of the polyurethane, e.g., of up to 50% of the amount of the polyurethane used, without any resulting disadvantages with regard to water and/or corrosion resistance and adhesion to the metallic surface, but also with respect to paint adhesion in case a further coating film is applied on top of a PC layer formed from the aqueous acidic coating composition. This is in particular advantageous for economic reasons, since commercially available and suitable polyurethanes, which are stable at an acidic pH value, are comparably expensive.

### DETAILED DESCRIPTION OF THE INVENTION

The term “comprising” in the sense of the present invention, for example in connection for example with the aqueous coating composition, preferably has the meaning of “consisting of”. With regard, e.g., to the aqueous coating composition it is possible—in addition to all mandatory constituents present therein—for one or more of the further optional constituents identified hereinafter to be also included therein. All constituents may in each case be present in their preferred embodiments as identified below.

The proportions and amounts in wt.-% (% by weight) of any of the constituents given hereinafter, which are present in each of the aqueous coating composition add up to 100 wt.-%, based in each case on the total weight of aqueous coating composition.

### Aqueous Composition

A first subject-matter of the present invention is an aqueous coating composition comprising besides water at least one film-forming polymer, at least one metal ion selected from the group of titanium, zirconium and hafnium ions, and mixtures thereof, and the at least one encapsulation structure.

The term “aqueous” with respect to the composition in the sense of the present invention preferably means that the composition is a composition containing at least 50 wt.-%, preferably at least 60 wt.-%, more preferably at least 65 wt.-% in particular at least 70 wt.-%, most preferably at least 70 and at most 90 wt.-% of water, based on its total content of organic and inorganic solvents including water. Thus, the composition may contain at least one organic solvent besides water-however, in an amount lower than the amount of water present. Preferably, the aqueous composition contains at least 50 wt.-%, preferably at least 60 wt.-%, more preferably at least 70 wt.-in particular at least 80 wt.-%, most preferably at least 90 wt.-% of water, in each case based on its total weight. The total amount of all constituents present in the inventive composition adds up to 100 wt.-%.

The aqueous coating composition can be acidic or alkaline, preferably is acidic. The term “acidic” means that the composition has a pH value of less than 7 at room temperature (23° C.). Preferably, when acidic, the aqueous coating composition has a pH value in a range of from 0.1 to <7.0, more preferably of from 0.5 to 6.5, still more preferably of from 1.0 to 6.0, even more preferably of from 1.5 to 5.5, still more preferably of from 2.0 to 5.0, yet more preferably of from 2.5 to 4.5, most preferably of from 3.0 to 4.0. The pH can be preferably adjusted by using nitric acid, aqueous ammonia and/or sodium carbonate. The term “alkaline” means that the composition has a pH value of >7 at room temperature (23° C.). Preferably, when alkaline, the aqueous coating composition has pH value in a range of from ≥7.0 to 14.0, more preferably of from >7.0 to 13.5, still more preferably of from >7.0 to 13.0, even more preferably of from >7.0 to 12.5, still more preferably of from >7.0 to 12.0, yet more preferably of from 7.5 to 11.5, still more preferably of from 8.0 to 11.0, yet more preferably of from 8.5 to 10.5.

The composition can be a dispersion or solution. Preferably, it is a dispersion.

Preferably, the aqueous coating composition does not comprise any pigments and/or fillers.

Preferably, the aqueous coating composition is free or essentially free of chromium (VI) ions, more preferably free or essentially free of any chromium ions.

Preferably, the aqueous coating composition contains the at least one encapsulation structure in an amount in a range of from 0.1 to 20 wt.-%, more preferably of from 0.2 to 18 wt.-%, still more preferably of from 0.3 to 16 wt.-%, even more preferably of from 0.4 to 14 wt.-%, still more preferably of from 0.5 to 12 wt.-%, yet more preferably of from 0.6 to 10 wt.-%, still more preferably of from 0.7 to 9.5 wt.-%, yet more preferably of from 0.8 to 9.0 wt.-%, still more preferably of from 0.9 to 8.5 wt.-%, most preferably of from 1.0 to 8.0 wt.-%, in each case based on the total weight of the aqueous coating composition.

Preferably, the aqueous coating composition has a solids content in a range of from 15 to 45 wt.-%, more preferably of from 20 to 40 wt.-%, even more preferably of from 20 to 35 wt.-%. The solids content is determined according to the method disclosed in the ‘method’ section.

### Encapsulation Structure Present in the Acidic Aqueous Coating Composition

The encapsulation structure comprises a polymeric shell and a core within the shell. The shell of the encapsulation structure is obtainable from polymerization of at least one (meth)acrylic monomer or from a monomer mixture comprising the at least one (meth)acrylic monomer, in the presence of the core, and the core comprises at least one preferably corrosion inhibiting constituent, said constituent having in its non-encapsulated state a water solubility at 23° C. of less than 50 g/L, wherein the core optionally further comprises at least one non-aqueous solvent. The core is surrounded by or embedded in the polymeric shell. The solubility in water is measured according to the method disclosed hereinafter in the ‘method’ section.

The encapsulation structure present in the aqueous coating composition is also referred to herein as ‘capsule’ or ‘microcapsule’. Capsules and methods for their preparation are, e.g., known from US 2020/108367 A1 and US 2019/159448 A1.

Preferably, the encapsulation structure has an average median d50 particle size diameter in a range of from 0.1 to 30 μm, more preferably of from 0.2 to 20 μm, even more preferably of from 0.3 to 15 μm, still more preferably of from 0.4 to 10 μm, yet more preferably of from 0.5 to 7.5 μm, still more preferably of from 0.5 to 5.5 μm, yet more preferably of from 0.5 to 4.0 μm, still more preferably of from 0.5 to 3.5 μm, most preferably from 0.6 to 3.0 μm. The method for determining the average median d50 particle size diameter is described hereinafter in the ‘methods’ section.

Preferably, the amount of the shell is in a range of from 1 to 70 wt.-%, more preferably of from 2 to 65 wt.-%, still more preferably of from 3 to 60 wt.-%, even more preferably of from 4 to 55 wt.-%, still more preferably of from 5 to 50 wt.-%, in case based on the total weight of the encapsulation structure comprising shell and core. The total weight of the encapsulation structure may be calculated by adding the weights of the shell and the core components used to make the encapsulation structure.

Preferably, for preparing the aqueous coating composition, an aqueous mixture comprising the encapsulation structure is used. The encapsulation structure is present in said aqueous mixture with water. Preferably, the mixture is an aqueous dispersion. Preferably, the mixture has a solids content in a range of from 1 to 70 wt.-%, more preferably of from 2 to 65 wt.-%, even more preferably of from 3 to 60 wt.-%, still more preferably of from 5 to 55 wt.-%, yet more preferably of from 10 to 50 wt.-%, in each case based on the total weight of the aqueous mixture. Preferably, the solids of the solids content of the mixture are attributable to the encapsulation structure present in the mixture.

### Core of the Inventively Used Encapsulation Structure

Preferably, the at least one corrosion inhibiting constituent present in the core has in its non-encapsulated state a water solubility at 23° C. of less than 40 g/L, more preferably of less than 30 g/L, even more preferably of less than 20 g/L, yet more preferably of less than 15 g/L, even more preferably of less than 10 g/L, still more preferably of less than 7.5 g/L, yet more preferably of less than 5.0 g/L, still more preferably of less than 2.5 g/L, most preferably of less than 1 g/L.

Preferably, the corrosion inhibiting constituent as such is solid or is liquid at 23° C. and atmospheric pressure.

Some suitable corrosion inhibiting constituents are, e.g., described in S. Gangopadhyay et al., J. Coat. Technol. Res. 2018, 15 (4), p. 789-807, M. L. Zheludkevich et al., Chem. Mater. 2007, 19, p. 402-411 and S. B. Ulaeto et al., Progress in Organic Coatings 2019, 136, 105276.

Preferably, the corrosion inhibiting constituent is an inorganic or organic constituent, more preferably is an organic compound, even more preferably an organic compound having at least one cycloaliphatic, heterocycloaliphatic, aromatic and/or heteroaromatic moiety, still more preferably having at least one C₃-C₄₀-cycloaliphatic moiety, at least one C₃-C₄₀-heterocycloaliphatic moiety, which comprises at least one heteroatom and/or at least one heteroatom group, wherein the heteroatom is in each case preferably selected from O, N and S, at least one C₅-C₄₀-aromatic moiety and/or at least one C₅-C₄₀-heteroaromatic moiety, which comprises at least one heteroatom and/or at least one heteroatom group, wherein the heteroatom is in each case preferably selected from O, N and S. Yet more preferably, the organic compound comprises at least one C₃-C₂₅-cycloaliphatic moiety, at least one C₃-C₂₅-heterocycloaliphatic moiety, which comprises at least one heteroatom and/or at least one heteroatom group, wherein the heteroatom is in each case preferably selected from O, N and S, at least one C₅-C₂₅-aromatic moiety and/or at least one C₅-C₂₅-heteroaromatic moiety, which comprises at least one heteroatom and/or at least one heteroatom group, wherein the heteroatom is in each case preferably selected from O, N and S.

Examples of corrosion inhibiting constituents are azole moiety containing compounds such as benzotriazole and/or benzothiazole. Further examples are 3-methylsalicylic acid, 4-methylsalicylic acid, 5-methylsalicylic acid, 6-methylsalicylic acid, 3-sulfosalicylic acid, 4-sulfosalicylic acid, 5-sulfosalicylic acid, 6-sulfosalicylic acid, 3-aminosalicylic acid, 4-aminosalicylic acid, 5-aminosalicylic acid, 6-aminosalicylic acid and salts thereof. Additional examples are benzimidazole, 1-methylbenzimidazole, 1-phenylbenzimidazole, 2-phenyl-benzimidazole, quinaldic acid, nicotinic acid, 1-pyrrolidinecarbodithioic acid ammonium salt, 1H-benzotriazole, 2-phosphonobutane-1,2,4-tricarboxylic acid salt (Bayhibit® S granulate, iminodiacetic acid, cupferron, 8-hydroxyquinoline, sodium metavanadate, 2-phosphonobutane-1,2,4-tricarboxylic acid (Bayhibit® AM), DL-tartaric acid, iron sulfate heptahydrate, phosphine carboxylic acid 1,1-diethoxy-ethyl ester-1-oxide, glutaric acid, L-(+)-ascorbic acid, L-(−)-malic acid, mercaptosuccinic acid, resorcinol, Rosin/Kollophonium, salicyl aldoxime, succinic acid, tannic acid, vanadyl acetylacetonate, zinc nitrate hexahydrate, 3,4,5-trihydroxybenzoic acid (gallic acid), 4-amino-3-hydroxy-1-naphthalenesulfonic acid, amidosulfonic acid, quercetine, quercetin dihydrate, 2,5-dimercapto-1,3,4-thiadiazole, 2-amino-6-methylbenzothiazole, barium 2,4-pentanedionate hydrate, benzimidazole, benzoin oxime, benzothiazole, biuret, CHE-COAT-CI L8AF, CHE-COAT-CI L8NF, ciprofloxacin, hydroquinone, N,N′-bis(salicylidene)-1,2-propanediamine, N,N′-Bis(salicylidene)ethylenediamine, N,N′-dibutylthiourea, N,N′-diethylthiourea, nitrile acetic acid, RIMA-FLASH OGP, 2-mercaptobenzothiazole, 2-nitrophenol, 3-amino-1H-triazole, 3-amino-5-mercapto-1,2,4-triazole, 3-hydroxy-3-methyl-2-butanone oxime, 4-hydroxybenzoic acid, 4-hydroxychalcone, bis(cyclohexanone)-oxaldihydrazone, Cholinhydroxide, dimethyl maleate, dimethyloxamide, dithiooxamide, dithizone, guanidine nitrate, guanidine thiocyanate, Halox® 570, 2-(1,3-benzothiazol-2-ylthio) succinic acid (Halox® Flash-X 350D), urea, hexafluoro titanic acid, imidazole, propargyl alcohol alkoxylate (Korantin® PM and Korantin® PP), benzyl pyridine-3-carboxylate, N-allylthiourea, N-amidinothiourea, naphthalene-2-sulfonic acid, neodymoxid, thiosalicylic acid, thiourea, thioacetamide, thiosemicarbazide, trithiocyanuric acid, HighTAC Additive G50, methyl-2-thiourea, quinoline, disodium dimercaptothiadiazole (Vanchem® NATD), N,N-bis(2-ethylhexyl)-ar-methyl-1H-benzotriazole-1-methanamine (Cuvan® 303), alkyl thiadiazole (Cuvan® 484), Cuvan® 826, Nacorr® 1352, Nacorr® 1351, Nacorr® 1651, Quartenary coco alkylamine ethoxylate dibutylthiourea (Armohib CI-31), Coferzol® TT-50, 3-(1H-tetrazol-5-yl) aniline, 1-(4-hydroxyphenyl)-5-mercaptotetrazole, 7-hydroxy-5-methyl[1,2,4]triazolo[1,5-a]pyrimidine, 1,2,4-triazole, 5-methyl-1H-benzotriazole, Coferzol® TT-HG, 5-aminotetrazole monohydrate, 5-mercapto-1-methyltetrazole, 3-mercapto-1,2,4-triazole, Rhodafac® ASI 80, 4-aminobenzoic acid (PABA), Perlastan® ON-60V, Impaphos® AEP (alpha-Hydro-omega-Hydroxy-Poly(Oxy-1,2-Ethanediyl) Mono-C12-14-Alkylethers, Phosphates), barium dinonylnaphthalenesulfonate/carboxylate (NaSul BSN-HAT), benzyldimethyltetradecylammonium bromide, benzylcetyldimethylammonium bromide, alkylbenzyldimethylammonium bromide, Loxanol® MI 6627, Complex triaminocaprionic acidtriazine (Additin® RC 5402), arylsulfonic carboxylic acid (Additin® RC 5428), Additin® RC 4810, Additin® RC 8239, 2-mercaptobenzoimidazole (MBI) and 1,2,4-triazole-3-thiol (TT). Preferred besides benzothiazole and benzotriazole are ciprofloxacin and quercetin.

Preferably, the core of the encapsulation structure comprises the at least one corrosion inhibiting constituent in amount of at least 10 wt.-%, more preferably of at least 20 wt.-%, still more preferably at least 30 wt.-%, even more preferably of at least 40 wt.-%, still more preferably of at least 50 wt.-%, even more preferably of at least 70 wt.-%, still more preferably of at least 80 wt.-%, yet more preferably of at least 90 wt.-%, more preferably of at least 95 wt.-%, still more preferably of at least 98 wt.-%, in each case based on the total weight of the core. In particular, the core consists of or essentially consists of the at least one corrosion inhibiting constituent.

The core optionally further comprises at least one non-aqueous solvent. The non-aqueous solvent preferably functions as carrier for dissolving the corrosion inhibiting constituent to generate a dispersed liquid oil phase before the polymerization and to generate afterwards the encapsulation core-shell structure is carried out as it will be outlined in detail hereinafter. The carrier may further assist the encapsulation of the at least one corrosion inhibiting constituent by assisting the at least one corrosion inhibiting constituent to remain in the core phase during polymerization of the shell or later during application: the presence of a carrier in the core may increase the retention of the corrosion inhibiting constituent inside the capsules. For example, some corrosion inhibiting constituents may be rather polar and may tend to have a faster release. Using a carrier may help to make sure via a favoured partitioning that the corrosion inhibiting constituents stay (longer) in the core and/or may help the partitioning between the polymeric shell and the core by creating a liquid mixture incompatible with the polymer.

Preferably, the at least one non-aqueous solvent optionally present in the core and preferably present in the core has a boiling point at atmospheric pressure of >100° C., more preferably of >125° C., still more preferably of >150° C., even more preferably of >175° C., still more preferably of >200° C., yet more preferably of >225° C., most preferably of >250° C.

Preferably, the at least one non-aqueous solvent optionally present in the core-which preferably is present in the core—has in its non-encapsulated state a water miscibility at 23° C. of less than 5 g/L, preferably of less than 2.5 g/L, more preferably of less than 2.0 g/L, even more preferably of less than 1.5 g/L, most preferably of less than 1.0 g/L. The miscibility with water is measured according to the method disclosed hereinafter in the ‘method’ section.

Preferably, the at least one non-aqueous solvent optionally present in the core-which preferably is present in the core—has in its non-encapsulated state a water miscibility at 23° C., which is lower in terms of g/L than the water solubility of the at least one corrosion inhibiting constituent present in the core (in its non-encapsulated state) at 23° C.

Preferably, the core comprises the at least one non-aqueous solvent in amount of at most 80 wt.-%, more preferably of at most 50 wt.-%, even more preferably of at most 30 wt.-%, still more preferably of at most 20 wt.-%, yet more preferably of at most 10 wt.-%, more preferably of at most 5 wt.-%, still more preferably of at most 2 wt.-%, in each case based on the total weight of the core. In particular, the core does not comprise or does essentially not comprise the at least one non-aqueous solvent.

Preferably, the at least one non-aqueous solvent is a hydrocarbon, more preferably an aliphatic hydrocarbon, wherein the hydrocarbon may—besides carbon and hydrogen atoms, however, optionally further contain heteroatom(s) or heteroatom groups(s), wherein the heteroatom is preferably selected in each case from N, S and O. More preferably, the at least one non-aqueous solvent has at least one aliphatic and/or heteroaliphatic moiety, still more preferably having at least one C₅-C₄₀-aliphatic moiety, at least one C₅-C₄₀-heteroaliphatic moiety, which comprises at least one heteroatom and/or at least one heteroatom group, wherein the heteroatom is in each case preferably selected from O, N and S. The at least one non-aqueous solvent may be preferably selected from ethers, esters and amides and mixtures thereof.

Examples of the at least one non-aqueous solvent are in particular: Guerbet alcohols based on fatty alcohols having 6 to 18, preferably 8 to 10, carbon atoms, amides of linear C₆-C₂₂-fatty acids with linear or branched C₆-C₂₂-fatty amines or amides of branched C₆-C₁₃-carboxylic acids with linear or branched C₆-C₂₂-fatty amines, amines having 6 to 18, preferably 8 to 10, carbon atoms, esters of linear C₆-C₂₂-fatty acids with linear or branched C₆-C₂₂-fatty alcohols or esters of branched C₆-C₁₃-carboxylic acids with linear or branched C₆-C₂₂-fatty alcohols, such as, for example, myristyl myristate, myristyl palmitate, myristyl stearate, myristyl isostearate, myristyl oleate, myristyl behenate, myristyl erucate, cetyl myristate, cetyl palmitate, cetyl stearate, cetyl isostearate, cetyl oleate, cetyl behenate, cetyl erucate, stearyl myristate, stearyl palmitate, stearyl stearate, stearyl isostearate, stearyl oleate, stearyl behenate, stearyl erucate, isostearyl myristate, isostearyl palmitate, isostearyl stearate, isostearyl isostearate, isostearyl oleate, isostearyl behenate, isostearyl oleate, oleyl myristate, oleyl palmitate, oleyl stearate, oleyl isostearate, oleyl oleate, oleyl behenate, oleyl erucate, behenyl myristate, behenyl palmitate, behenyl stearate, behenyl isostearate, behenyl oleate, behenyl behenate, behenyl erucate, erucyl myristate, erucyl palmitate, erucyl stearate, erucyl isostearate, erucyl oleate, erucyl behenate and erucyl erucate. Also suitable are esters of linear C₆-C₂₂-fatty acids with branched alcohols, in particular 2-ethylhexanol, esters of C₁₈-C₃₈-alkyl hydroxy carboxylic acids with linear or branched C₆-C₂₂-fatty alcohols, in particular dioctyl malate, esters of linear and/or branched fatty acids with polyhydric alcohols (such as, for example, propylene glycol, dimerdiol or trimertriol) and/or Guerbet alcohols, triglycerides based on C₆-C₁₀-fatty acids, liquid mono-/di-/triglyceride mixtures based on C₆-C₁₈-fatty acids, esters of C₆-C₂₂-fatty alcohols and/or Guerbet alcohols with aromatic carboxylic acids, in particular benzoic acid, esters of C₂-C₁₂-dicarboxylic acids with linear or branched alcohols having 1 to 22 carbon atoms or polyols having 2 to 10 carbon atoms and 2 to 6 hydroxyl groups, vegetable oils, branched primary alcohols, substituted cyclohexanes, linear and branched C₆-C₂₂-fatty alcohol carbonates, such as, for example, dicaprylyl carbonate (Cetiol® CC), Guerbet carbonates, based on fatty alcohols having 6 to 18, preferably 8 to 10, carbon atoms, esters of benzoic acid with linear and/or branched C₆-C₂₂-alcohols, linear or branched, symmetrical or asymmetrical dialkyl ethers having 6 to 22 carbon atoms per alkyl group, such as, for example, dicaprylyl ether, ring-opening products of epoxidized fatty acid esters with polyols, silicone oils (cyclomethicones, silicone methicone grades, etc.), aliphatic or naphthenic hydrocarbons, such as, for example, squalane, squalene or dialkylcyclohexanes, and/or mineral oils. In one form the oil comprises preferably aliphatic or naphthenic hydrocarbons, and/or mineral oils.

Examples of suitable non-aqueous solvents are commercial products of the BASF Cetiol® or Agnique® series such as Cetiol® B, Cetiol® OE, Cetiol® Sensoft and Agnique® AMD 10. Agnique® AMD 10 is N, N-dimethyldecan-1-amide, Cetiol® OE is a dicaprylyl ether, Cetiol® Sensoft is the 2-propylheptylester of octanoic acid and Cetiol® B is a liquid adipic acid ester. These solvents are considered as “green” solvents.

### Shell of the Inventively Used Encapsulation Structure

The shell of the encapsulation structure is polymeric. The shell may be a homopolymer in case only one kinds of monomers such as precisely one (meth)acrylic monomer m1 are used for its preparation. It may, however, also be a copolymer and preferably is a copolymer prepared form more than one kind of monomers.

The term “(meth)acryl” means “acryl” and/or “methacryl”. Similarly, “(meth)acrylate” means acrylate and/or methacrylate. The shell is a “(meth)acryl polymer”, which is formed at least partially from “acryl monomers” and/or “methacryl monomers”, but additionally may contain non-acryl and non-methacryl monomeric units if other ethylenically unsaturated monomers such as vinyl monomers are additionally used for its preparation. Preferably, the shell is formed from more than 40 wt.-%, even more preferably of from more than 50 wt.-%, still more preferably of more than 60 wt.-% of (meth)acryl monomers.

Preferably, the shell is obtainable from at least one (meth)acrylic monomer m1, from at least monomer m2, from a monomer mixture comprising the at least one (meth)acrylic monomer m1 and optionally at least one further monomer m2 and/or optionally at least one further monomer m3, or from a monomer mixture comprising the at least one monomer m2 and optionally at least one further monomer m1 and/or optionally at least one further monomer m3, both m2 and m3 being different from one another and from monomer m1,
wherein the at least one (meth)acrylic monomer m1 is a non-functionalized (meth)acrylic monomer, preferably is a (meth)acrylic ester of an aliphatic C₁-C₃₀-monoalcohol,
wherein monomer m2 being optionally present in the monomer mixture is a monomer having at least one ethylenically unsaturated group and further bearing at least one functional group, said at least one functional group being preferably selected from hydroxyl groups, ether groups, carbonyl groups, amino groups, epoxide groups, carboxylic acid groups, sulfur atoms containing functional groups and phosphorous atom(s) containing groups, wherein monomer m2 preferably is a (meth)acrylic monomer, and
wherein monomer m3 being optionally present in the monomer mixture is a monomer having at least two ethylenically unsaturated groups.

Monomer m1 is preferably a (meth)acrylic monomer, which bears a hydrophobic group. Preferably, m1 contains precisely one (meth)acrylic group. Examples of (meth)acrylic esters of aliphatic C₁-C₃₀-monoalcohols, which can be used as monomer m1 are methyl (meth)acrylate, ethyl (meth)acrylate, n-propyl (meth)acrylate), i-propyl (meth)acrylate, n-butyl (meth)acrylate, i-butyl (meth)acrylate, t-butyl (meth)acrylate, lauryl (meth)acrylate, 2-ethylhexyl (meth)acrylate, 3-propylheptyl (meth)acrylate, stearyl (meth)acrylate, behenyl (meth)acrylate, benzyl (meth)acrylate, cyclohexyl (meth)acrylate and isobornyl (meth)acrylate.

Monomer m2 is used in order to preferably functionalize the shell of the encapsulation structure. Monomer m2 is preferably a monomer selected from vinylic and/or (meth)acrylic monomers. Preferably, m2 contains precisely one (meth)acrylic group or precisely one vinylic group. Examples of sulfur atom(s) containing groups present as functional group of monomer(s) m2 are thiol groups, thioether groups, thioester groups and thiocarboxylic acid groups as well as mixtures thereof, more preferably thioether groups, thioester groups and thiocarboxylic acid groups as well as mixtures thereof. Examples of phosphorous atom(s) containing groups present as functional group of monomer(s) m2 are phosphonic acid groups, phosphoric acid groups as well as mixtures thereof. Examples of monomers, which can be used as monomers m2, are 2-hydroxyethyl acrylate, 2-hydroxyethyl methacrylate, 3-hydroxypropyl acrylate, 3-hydroxypropyl methacrylate, 4-hydroxybutyl acrylate, 4-hydroxybutyl methacrylate, 3-phenoxy-2-hydroxypropyl (meth)acrylate, glycerol mono (meth)acrylate, N-(2-hydroxypropyl) (meth)acrylamide, allyl alcohol, hydroxystyrene, hydroxyalkyl vinyl ethers such as hydroxybutyl vinyl ether and vinylbenzyl alcohol as well as acrylic acid and methacrylic acid, vinyl mercapto alcohols such as vinyl mercaptoethanol, vinyl thiazoles and vinyl thiophenes, glycidyl (meth)acrylate, N,N-dimethylaminoethyl acrylate, N,N-dimethylaminoethyl methacrylate, N,N-dimethylaminopropyl acrylate, N,N-dimethylaminopropyl methacrylate, 2-(N,N-diethylamino)ethyl (meth)acrylate, 2-(N,N-dimethylamino)ethyl (meth)acrylate, N-[3-(N,N-dimethylamino)propyl] (meth)acrylamide, 3-dimethylaminoneopentyl (meth)acrylate, 2-N-morpholinoethyl (meth)acrylate, N-[3-(N, N-dimethylamino)propyl] (meth)acrylamide, 2-(N,N-diethylamino)ethyl (meth)acrylamide, 2-(tert-butylamino)ethyl (meth)acrylate, 2-diisopropylaminoethyl (meth)acrylate, N-dodecylacrylamide and N-[2-(N,N-Dimethylamino)ethyl] (meth)acrylamide, N,N-Dimethyl (meth)acrylamide, 2-vinylpyridine, 4-vinylpyridine, allyl amine, (meth)acryl amide and vinylimidazole, N-vinyl-pyrrolidone, vinyl acetate, N-vinylformamide, as well as N, N-diethylaminostyrene (all isomers) and N,N-diethylamino-alpha-methylstyrene (all isomers) as well as vinyl phosphonic acid. Vinyl mercaptoethanol is particularly preferred.

It is also possible to introduce, e.g., the sulfur-containing group afterwards in a polymer analogous reaction. Preferably, in case of introducing said moiety after the polymerization has taken place, a monomer comprising a suitable moiety for later modification is used for polymerization as monomer m2. Preferably, at least one monomer selected from the group consisting of preferably (meth)acrylic monomers having at least one epoxide group are used. Most preferred is glycidyl (meth)acrylate. For introducing the at least one sulfur-containing moiety a suitable S-containing compound is used, preferably a compound having at least one thiol group. Said thiol group can react with the epoxide moiety after ring opening of the epoxide group and form the at least one sulfur-containing moiety. Preferably, the S-containing compound is selected from the groups consisting of dithiols such as 1,2-ethandithiols, mercaptoalcohols such as mercapoethanol, thiocarboxylic acids such as thioacetic acid (CH₃—C(═O)SH), mercaptoacids such as HS—CH₂—C(═O)OH, mercaptoacid esters such as HS—CH₂—C(═O)R, wherein R is a hydrocarbyl group, preferably is an aliphatic group, and mercapto-functional compounds bearing more than one further functional group such as both at least one amino and at least one carboxylic acid groups, e.g. L-cysteine.

As outlined hereinbefore monomer m3 has at least two ethylenically unsaturated groups, which preferably are non-conjugated. If precisely two ethylenically unsaturated groups are present, the monomer represents a difunctional monomer. A difunctional monomer can be a defined small molecule or can be based on a polymer. For example, linear end-functional polymers can be modified to generate difunctional crosslinkers to be in turn used as difunctional monomers. In some cases, vinylic bonds can be introduced in the main polymer chain during the polymer synthesis too. Polymer-based difunctional monomers can be described as difunctionalized monomers. If more than two ethylenically unsaturated groups are present, the monomer represents a multifunctional monomer. A multifunctional monomer can be a defined small molecule or can be based on a polymer. For example, branched or hyperbranched end-functional polymers can be modified to generate multifunctional crosslinkers to be in turn used as multifunctional monomers. In some cases, vinylic bonds can be introduced in the main polymer chain during the polymer synthesis too. Polymer-based multifunctional monomers can be described as polyfunctionalized monomers.

Monomer m3 is preferably a monomer selected from vinylic and/or (meth)acrylic monomers. Monomer m3 preferably serves as crosslinking monomer since it bears at least two ethylenically unsaturated groups when forming the polymeric shell. Preferably, it has at least two vinylic or at least two (meth)acrylic groups. Suitable difunctional monomers are divinyl benzene (DVB), divinyl cyclohexane, diesters of diols with (meth)acrylic acid and diallyl and divinyl ethers of such diols as, e.g., ethanediol di(meth)acrylate, ethylene glycol dimethacrylate, 1,3-butylene glycol dimethacrylate, methallylmethacrylamide and allyl (meth)acrylate. Suitable difunctionalized monomers are PEG di(meth)acrylate, PPG di(meth)acrylate, polyglycerol di(meth)acrylates, polyurethane di(meth)acrylate resins and polyester di(meth)acrylates. Suitable polyfunctionalized monomers are PEG bearing more than two (meth)acrylate groups, PPG bearing more than two (meth)acrylate groups, polyglycerols with more than two (meth)acrylate groups, polyurethanes with more than two (meth)acrylate groups and polyesters with more than two (meth)acrylate groups. Further suitable polyfunctionalized monomers are polyesters of polyols with (meth)acrylic acid and the polyallyl and polyvinyl ethers of such polyols, trivinylbenzene and trivinylcyclohexane. Specific examples of difunctional monomers m3 are 1,4-butanediol diacrylate (BDDA), 1,4-butanediol dimethacrylate, 1,5-pentanediol di(meth)acrylate, 1,6-hexandiol di(meth)acrylate, methacrylic acid anhydride (MAA) and divinyl benzene (DVB) as well as divinyl cyclohexane. Specific examples of multifunctional monomers m3 are trivinylbenzene, trivinylcyclohexane, trimethylolpropane tri(meth)acrylate, pentaerythritol tetraallyl ether and pentaerythritol tri(meth)acrylate. Incorporation of monomeric units mu3 derived from monomer m3 is advantageous as its presence avoids the early release of the corrosion inhibiting compound upon storage of the microcapsule dispersion by generating a dense crosslinked polymeric network around the core. Nevertheless, upon application on metal surface, mu3 facilitates release or optimizes the rate of release of the corrosion inhibiting compound from the polymeric shell of the encapsulation structure, if necessary, e.g., at corrosion front. For example, BDDA is sensitive to alkaline pH, where the corrosion happens. The higher the amounts of monomeric units mu3 in the shell, the slower is the early release before application, since the shell is more “crosslinked”. However, at the corrosion front where the pH is higher, the crosslinker will hydrolyze leading to a polarity change of the shell and an optimal release of the corrosion inhibiting compound. On the other hand, the amounts of monomeric units mu3 should preferably not be too high since this could lead to an undesired formation of aggregates during the microcapsules manufacture.

Further monomers such as at least one monomer m4 may be optionally further used for preparing the shell. Examples of such monomers m4 are non-functional such as non-(meth)acrylic non-functional monomers, e.g., styrene.

Preferably, monomer(s) m3 are used besides monomer(s) m1 for preparing the shell. The polymeric shell is thus preferably at least branched or fully crosslinked due to use of monomer(s) m3.

Preferably, the shell
contains only monomeric units mu1 derived from the at least one (meth)acrylic monomer m1 and no other monomeric units besides monomeric units m1, or contains monomeric units mu1 derived from the at least one (meth)acrylic monomer m1 in an amount in a range of from 60 to 99 wt.-%, preferably of from 65 to 95 wt.-%, more preferably of from 70 to 90 wt.-%, and monomeric units mu2 derived from the at least one monomer m2 in an amount in a range of from 1 to 40 wt.-%, preferably of from 5 to 35 wt.-%, more preferably of from 10 to 30 wt.-%,
or contains monomeric units mu1 derived from the at least one (meth)acrylic monomer m1 in an amount in a range of from 40 to 99 wt.-%, preferably of from 50 to 95 wt.-%, more preferably of from 50 to 90 wt.-%, and monomeric units mu3 derived from the at least one monomer m3 in an amount in a range of from 1 to 60 wt.-%, preferably of from 5 to 50 wt.-%, more preferably of from 10 to 50 wt.-%,
or contains monomeric units mu1 derived from the at least one (meth)acrylic monomer m1 in an amount in a range of from 30 to 98 wt.-%, preferably of from 36 to 92 wt.-%, more preferably of from 44 to 86 wt.-%, monomeric units mu2 derived from the at least one monomer m2 in an amount in a range of from 1 to 35 wt.-%, preferably of from 4 to 32 wt.-%, more preferably of from 5 to 25 wt.-%, and monomeric units mu3 derived from the at least one monomer m3 in an amount in a range of from 1 to 50 wt.-%, preferably of from 2 to 45 wt.-%, more preferably of from 5 to 40 wt.-%.

The sum of all monomers used for preparing the shell, of course, adds up to 100 wt.-% in each case.

Preferably, the amounts of monomeric units mu1 in the shell in wt.-% exceeds the amount of any monomeric units mu2 and/or mu3 also present.

### Preparation of the Encapsulation Structure

The encapsulation structure present in the aqueous coating composition preferably is obtainable by a method comprising at least steps a) and b), namely by
a) providing a mixture of (i) the at least one (meth)acrylic monomer or of the monomer mixture comprising the at least one (meth)acrylic monomer suitable for formation of the polymeric shell of the encapsulation structure, (ii) the at least one corrosion inhibiting constituent suitable for formation of the core of the encapsulation structure, wherein the corrosion inhibiting constituent can be optionally present in a mixture further comprising at least one non-aqueous solvent, said mixture being suitable for forming an oil phase, and then emulsify into (iii) water as aqueous continuous phase, wherein optionally at least one emulsifier and/or surfactant is present, preferably is present, in the aqueous continuous phase (iii) and/or in the mixture formed from (i) and (ii) (the oil phase), and
b) polymerizing the at least one (meth)acrylic monomer or the monomer mixture comprising the at least one (meth)acrylic monomer to form the shell of the encapsulation structure comprising as a core within the shell formed upon polymerization the at least one corrosion inhibiting constituent, wherein the core may optionally further comprise at least a part of the at least one non-aqueous solvent.

In step a) (i) and (ii) are dispersed in water (iii). (i) and (ii) form a hydrophobic phase (oil phase), whereas (iii) forms an aqueous phase used as continuous phase. Thus, as two phases are present, the method comprising steps a) and b) preferably is an oil-in-water emulsion polymerization. A corrosion inhibiting compound can be in particular used as such as (ii) without any non-aqueous solvent, when the compound is liquid at 23° C. and atmospheric pressure. In case the compound is solid at 23° C. and atmospheric pressure and the monomer(s) used for preparing the shell are not able to dissolve the compound, it preferably is dissolved with the aid of at least one non-aqueous solvent in order to generate a liquid oil phase before emulsifying the oil phase into water.

As outlined above the method comprising steps a) and b) preferably is an oil-in-water emulsion polymerization, in particular when a mixture of the corrosion inhibiting constituent and at least one non-aqueous solvent is used. During formation of the microcapsules, the shell monomers are polymerized to form the polymeric shell around the core. Polymerizing the shell monomers may form microcapsules comprising a core of the oil phase within a polymeric shell. Preferably shell monomers are present in the oil phase during the emulsification and the polymerization.

One or more emulsifiers and/or one or more surfactants may be used for generating a stable emulsion and/or suspension. These may be dissolved into the aqueous continuous phase and/or into the oil phase to assist emulsification of the oil phase.

One or more polymerization stabilizers may be used. A polymerization stabilizer may be included in the continuous aqueous phase and/or oil phase, preferably in the aqueous phase. The polymerization stabilizer may be a hydrophilic polymer, for example a polymer containing hydroxyl groups, e.g., a polyvinyl alcohol. The polyvinyl alcohol may be used in form of an aqueous solution thereof. The polyvinyl alcohol may be derived from polyvinyl acetate, wherein some or all of the vinyl acetate groups are hydrolyzed to vinyl alcohol units. Other kinds of polymerization stabilizers are suitable nanoparticles, which allow a pickering stabilization.

Preferably, the polymerization is a free radical polymerization. Hence, preferably, one or more initiator compounds are used such as redox initiators and/or thermal initiators. Suitable thermal initiators are, e.g., dialkyl peroxides, hydroperoxides, peroxyesters, peroxyketals, dacylperoxides, peroxy (di) carbonates, persulphates and/or azo initiators. Redox initiators may include a reducing agent such as sodium sulphite, sulphur dioxide and an oxidizing compound such as ammonium persulphate or a suitable peroxy compound, such as tertiary butyl hydroperoxide.

Preferably, step b) is performed at a temperature in a range of from 5 to 100° C., more preferably of from 40 to 95° C.

### Metal Ion(s)

The aqueous coating composition comprises at least one metal ion selected from the group of titanium ions, zirconium ion, hafnium ions, and mixtures thereof. When the aqueous coating composition is acidic, said at least one metal ion preferably in each case is present or used at least in the form of its/their complex fluoride(s). When the aqueous coating composition is alkaline, said at least one metal ion preferably in each case is present or used at least in the form of its/their carbonates and/or complex carbonates and/or in form of its lactate, preferably in each case in a form, which is free of fluoride. Particularly preferred are titanium ions, and zirconium ions, and mixtures thereof. Most preferred are zirconium ions, when the metallic surface to be treated in the inventive treatment method described hereinafter, is of or contains aluminum. Most preferred are titanium ions, when the metallic surface to be treated in the inventive treatment method described hereinafter, is of or contains steel and/or zinc and/or zinc and aluminum alloys and/or zinc, aluminum and magnesium alloys. Examples of metal substrates containing aluminum or being based on aluminum are Galvalume® and Galfan®.

Preferably, the at least one metal ion selected from the group of titanium, zirconium, hafnium ions and mixtures thereof, preferably selected from the group of zirconium and titanium ions, is present in the composition in an amount in a range of from 50 to 50000 ppm, more preferably of from 75 to 40000 ppm, still more preferably of from 100 to 30000 ppm, even more preferably of from 125 to 20000 ppm, yet more preferably of from 150 to 15000 ppm, in particular of from 175 to 10000 ppm, more particularly of from 200 to 8000 ppm, most preferably of from 300 to 6000 ppm, in each case calculated as metal. The content can be monitored and determined by the means of ICP-OES (optical emission spectroscopy with inductively coupled plasma).

Preferably, a precursor metal compound is used to generate the metal ions. Preferably, the precursor metal compound is water-soluble.

Particularly preferred titanium, zirconium and hafnium compounds used as precursor metal compounds are the complex fluorides of these metals, in particular when the aqueous composition is acidic. The term “complex fluoride” includes the single and multiple protonated forms as well as the deprotonated forms. It is also possible to use mixtures of such complex fluorides. Complex fluorides in the sense of the present invention are complexes of titanium, zirconium and/or hafnium formed with fluoride ions in the composition, e.g., by coordination of fluoride anions to titanium, zirconium and/or hafnium cations in the presence of water.

Moreover, zirconium can also be added in form of zirconyl compounds as, e.g., zirconyl nitrate and zirconyl acetate; or zirconium carbonate or zirconium nitrate, the latter one being particularly preferred, in particular when the aqueous composition is acidic. The same applies to titanium and hafnium. As outlined above, other precursor compounds can be used as well such as, e.g., zirconium carbonate, in particular when the aqueous composition is alkaline.

### Film-Forming Polymer

Preferably, the at least one film-forming polymer is different from the polymeric shell of the encapsulation structure.

The film-forming polymer represents a binder. For the purposes of the present invention, the term “binder” is preferably understood in accordance with DIN EN ISO 4618 (German version, date: March 2007) to be the non-volatile (solid) constituent of a coating composition, which is responsible for the film formation. The term includes crosslinking agents (crosslinkers) and additives such as catalysts if these represent non-volatile constituents. Pigments and/or fillers are not subsumed under the term “binder” as these are not responsible for film formation. The term “polymer” is known to the person skilled in the art as well and, for the purposes of the present invention, encompasses polyadducts and polymerizates as well as polycondensates. The term “polymer” includes both homopolymers and copolymers.

Any type of film-forming polymers can be used. In particular, polymers as disclosed in US 2013/0177768A 1 are suitable. Most preferred are cationic and/or non-ionic polymers.

Preferably, the aqueous coating composition comprises at least two film-forming polymers being different from one another, more preferably at least one (meth)acrylic polymer or copolymer, and at least one polymer comprising at least one polyurethane moiety. In this case, preferably, the amount of the (meth)acrylic polymer or copolymer present preferably exceeds the amount of the at least one polymer comprising at least one polyurethane moiety.

Any type of (meth)acrylic polymers or copolymers can be used. Copolymers are preferred. These copolymers may comprise monomeric units from non-(meth)acrylic monomers such as vinylic monomers.

Polymers comprising at least one polyurethane moiety preferably have a content of a polyether, preferably of a polycarbonate. Cationic polymers comprising at least one polyurethane moiety are in particular preferred. Examples are polyester-polyurethanes, polyester-polyurethane-poly(meth)acrylates, polycarbonate-polyurethanes, and/or polycarbonate-polyurethane-poly(meth)acrylate.

Hydrophilic cationic groups are preferably incorporated into the skeleton and/or into side chains of the cationic polymer comprising at least one polyurethane moiety via at least one amine, in particular via at least one alkanolamine such as an N-alkyldialkanolamine, for example. Quaternary ammonium groups are preferably incorporated into the main chain of the cationic polymer comprising at least one polyurethane moiety. These groups may optionally have acid groups as anionic counterions, and/or quaternization agent groups, which form, for example, when acetic acid and/or phosphoric acid, for example, is/are used as acid, and/or dibutyl sulfate and/or benzyl chloride, for example, is/are used as quaternization agent.

### Further Constituents of the Aqueous Coating Composition

The aqueous composition may comprise further constituents as lined out in the hereinafter. The term “further comprises”, as used herein throughout the description in view of the ingredients of the aqueous compositions, means “in addition to the mandatory constituents (encapsulation structure, metal ion selected from the group of titanium, zirconium, and hafnium ions, and mixtures thereof, film-forming polymer as well as water). Therefore, such “further” constituents include ions different from the above mentioned metal ions.

The aqueous composition preferably contains free fluorides. These may result from the presence of the metal ions as mentioned hereinbefore, i.e., in particular when complex fluorides of Ti, Zr and/or Hf are present, but may also or alternatively result from the presence of other optional components as described hereinafter. Preferably, the aqueous composition contains free fluoride ions in an amount in the range of from 1 to 500 ppm, more preferably of from 1.5 to 200 ppm, even more preferably of from 2 to 100 ppm, in particular of from 2.5 to 50 ppm. The free fluoride content is determined by means of a fluoride ion sensitive electrode.

Optionally, the aqueous composition further comprises at least one kind of metal cations selected from the group of cations of metals of the 1^{st} to 3^{rd} subgroup (copper, zinc and scandium groups) and 5th to 8th subgroup (vanadium, manganese and iron groups) of the periodic table of the elements including the lanthanides as well as the 2^{nd} main group of the periodic table of the elements (alkaline earth metal group), lithium and bismuth.

Optionally, the aqueous composition further comprises at least one pH-Value adjusting substance, preferably selected from the group consisting of nitric acid, sulfuric acid, methanesulfonic acid, acetic acid, aqueous ammonia, sodium hydroxide and sodium carbonate, wherein nitric acid, phosphoric acid, aqueous ammonia and sodium carbonate are preferred. Depending on the pH value of the aqueous composition, the above compounds can be present in their fully or partially deprotonated form or in protonated forms.

Optionally, the aqueous composition further comprises at least one complexing agent. An example is 1-Hydroxyethane-1,1-diphosphonic acid (HEDP).

Optionally, the aqueous composition further comprises at least one water-soluble fluorine compound. Examples of such water-soluble fluorine compounds are fluorides as well as hydrofluoric acid. In particular, such a compound is present in the composition, when the aforementioned metal ion(s) is/are not present in the form of a complex fluoride of titanium, zirconium and/or hafnium in the composition.

Optionally, the aqueous composition further comprises at least one organosilane. Examples are, e.g., (3-aminopropyl) trimethoxysilane, (3-aminopropyl)triethoxysilane, N-2-aminoethyl-3-aminopropyltrimethoxysilane, (3-mercaptopropyl) trimethoxysilane, (3-mercaptopropyl)triethoxysilane, (3-glycidyloxypropyl) trimethoxysilane and/or (3-glycidyloxypropyl)triethoxysilane, vinyltrimethoxysilane, in particular when the aqueous composition is acidic.

Optionally, the aqueous composition further comprises at least one organic acid, preferably at least one organic acid having at least two carboxylic acid groups and/or at least one organic acid having at least one carboxylic acid groups and at least one further functional group having at least one donor atom such an OH-group, e.g., lactic acid, in particular when the aqueous composition is alkaline. The presence of such a compound may be helpful for stabilization of the at least one metal ion in the composition such as Zr cations.

The aqueous composition may further comprise at least one of the following constituents: one or more waxes, one or more wetting agents and one or more defoamers.

### Use of the Aqueous Coating Composition

A further subject-matter of the present invention is a use of the inventive aqueous coating composition for corrosion protection of metallic substrates, in particular for and/or by releasing the corrosion inhibiting compound present within the shell of the encapsulation structure, which is present in the aqueous coating composition, preferably after having applied the aqueous coating composition at least in portion onto a surface of an optionally pre-coated metallic substrate to form a coating film at least in portion on said surface.

Preferably, the metallic substrate is a substrate made at least partially of steel, preferably galvanized steel, steel alloys, aluminum, aluminum alloys, zinc, zinc alloys, and mixtures thereof, more preferably made at least partially of steel and/or steel alloys and/or zinc and/or zinc and aluminum alloys and/or zinc, aluminum and magnesium alloys. Preferably, the metallic substrate is not pre-coated.

All preferred embodiments described above herein in connection with the inventive aqueous coating composition and preferred embodiments thereof are also preferred embodiments of the inventive use.

### Method for Treatment

A further subject-matter of the present invention is a method for treatment of at least one surface of an optionally pre-coated metallic substrate comprising at least step 1) and optionally also step 2), namely
1) applying the inventive aqueous coating composition at least in portion onto the at least one surface of the metallic substrate to form a coating film at least in portion on said surface, and
2) optionally curing or drying the coating film obtained after step 1) to give a cured or dried coating layer, wherein the obtained cured or dried coating layer preferably has a dry film thickness below 2.0 μm.

All preferred embodiments described above herein in connection with the inventive aqueous coating composition, the inventive use, and in each case the preferred embodiments thereof, are also preferred embodiments of the inventive treatment method.

Preferably, the metallic substrate is not pre-coated. The metallic substrate is preferably made of at least one metal, preferably made of steel, in particular galvanized steel. However, substrates containing or being made of aluminum and/or of an aluminum alloy may also be used although steel substrates are preferred. The surface of the substrate can consist of different regions comprising different metals and/or alloys. However, at least one region of the surface of the substrate is preferably of steel. Preferably, the overall surface of the substrate is made of or comprises steel.

Preferably, the metallic substrate is a substrate made at least partially of steel, preferably galvanized steel, steel alloys, aluminum, aluminum alloys, zinc, zinc alloys, and mixtures thereof, more preferably made at least partially of steel and/or steel alloys and/or zinc and/or zinc and aluminum alloys and/or zinc, aluminum and magnesium alloys. Examples of metal substrates containing aluminum or being based on aluminum are Galvalume® and Galfan®.

The coating film obtained after step 1) is preferably suitable to provide a permanent coating (PC) layer such as the coating layer obtained after performance of step 2).

Preferably, in optional step (2) the coating film obtained after step 1) is dried. Drying in particular means physical drying. Preferably, optional step (2) is performed at a peak metal temperature (PMT) in a range of from 50 to 90° C., more preferably 60 to 80° C.

Preferably, the obtained cured or dried coating layer has a dry film thickness in a range of from 0.1 to <2.0 μm, more preferably of from 0.3 to 1.9 μm, in particular of from 0.5 to 1.7 μm, most preferably of from 0.7 to 1.5 μm.

The method may comprise an additional step 3), namely applying at least one further coating composition to the coating film present on the surface of the substrate obtained after step 1) or to the coating layer present on the surface of the substrate obtained after optional step 2) to form a further coating film layer upon the surface. Said at least one further coating composition is different from the composition applied in step 1).

The coating composition used in step 3) preferably comprises at least one polymer being suitable as binder. Preferably, the coating composition used in step 3) is a powder coating composition and is applied after step 2). Any conventional powder coating composition may be used in such a step.

### Coated Substrate

A further subject-matter of the present invention is a metallic substrate comprising at least one surface, wherein said at least one surface has been treated according to the inventive treatment method.

All preferred embodiments described above herein in connection with the inventive aqueous composition, the inventive use, the inventive treatment method and in each case the preferred embodiments thereof, are also preferred embodiments of the inventive coated substrate.

### METHODS

### 1. Solid Content

The solid content (non-volatile content) is determined via DIN EN ISO 3251:2008-06 at 105° C. for 120 min.

### 2. Average Particle Size Diameter

Particle size distribution of the capsules is measured using a Malvern Mastersizer 2000 by laser diffraction according to ISO 13320 EN: 2020-01. The data were treated according to the Mie-Theory by software using a “universal model” provided by Malvern Instruments. Important parameters are the dn-values for n=10, 50 and 90, the d10, d50 and d90 values. The d50 value is the average volume based median d50 particle size diameter.

### 3. Neutral Salt Spray (NSS) Testing

The NSS test is used for determining the corrosion resistance of a coating on a substrate. In accordance with DIN EN ISO 9227:2017-07 the samples under analysis are in a chamber in which there is continuous misting of a 5% strength sodium chloride salt solution at a temperature of 50° C. for a duration of 120 hours with controlled pH. The spray mist deposits on the samples under analysis, covering them with a corrosive film of salt water. The extent of the corrosion can be assessed on the basis of characteristic values in the range from 0 (no corrosion) to 5 (significant corrosion). Each of the tests is performed three times and an average value is determined.

### 4. Wet Stack Test

The wet stack test is performed for 240 h at 60° C. and simulates the storage and transport of coils in hot and humid regions.

### 5. Crosscut Testing

The crosscut test is used to ascertain the strength of adhesion of a coating on a substrate in accordance with DIN EN ISO 2409:2020-12. Cutter spacing is 2 mm. Assessment takes place on the basis of characteristic cross-cut values in the range from 0 (very good adhesion) to 5 (very poor adhesion). The crosscut test is performed before and after exposure for 240 hours in a condensation clima according to DIN EN ISO 6270-2 CH:2018-04. Each of the tests is performed three times and an average value is determined.

### 6. Water Solubility

Water solubility, in particular of the corrosion inhibiting constituent, is measured at 23° C. (at atmospheric pressure and at pH 7.0). The measurement method including sample preparation is described in OECD Guideline 105.

### 7. Water Miscibility

Water miscibility, in particular of the non-aqueous solvent, is measured at 23° C. (at atmospheric pressure and at pH 7.0) according to ASTM D1722.

### EXAMPLES

The following examples further illustrate the invention but are not to be construed as limiting its scope.

### 1. Preparation of Encapsulated Corrosion Inhibitors

### 1.1 General Preparation Protocol

Water and an aqueous solution of a commercially available polyvinyl alcohol (10 wt.-%) were mixed to give a mixture 1. The pH value was adjusted with aqueous sulfuric acid (20 wt.-% solution) to a pH value in a range of from pH 2.5 to 3.5. Mixture 1 contained an amount of polyvinyl alcohol of 7.5 wt.-%, based on the total weight of mixture 2 described hereinafter. Separately, a mixture 2 of corrosion inhibitor to be encapsulated, a carrier, and the monomer(s) to be used for preparing the shell (wall) of the capsule such as, e.g., at least one hydrophobic monomer and at least one monomer having at least one functional group, and optionally a crosslinker such as crosslinking monomer, was prepared. Mixture 2 was then emulsified in mixture 1 using a silent crusher (rotor stator dispersion tool) for 5 min at 26.000 rpm. Temperature of the emulsion was maintained below 35° C. during the emulsification step using an ice bath. The emulsion was then transferred to a round bottom flask equipped with a half-moon stirrer and a water-condenser and stirred at 150 rpm. Nitrogen gas was flown in the reactor over the whole polymerization. Radical initiator (thermal initiator) was then added to the media and the temperature was raised: Starting from 20° C., 75° C. is reached over 60 minutes (linear rate). This temperature was maintained for 2 hours. Then, the temperature was raised to 85° C. within 15 min (linear rate) and held for 60 min. Afterwards, the system was cooled down to room temperature (23° C.). At the beginning of the cooling initiators (redox initiator partners) were added to the media to decrease the residual monomer content.

1.2 a Number of Capsules were Prepared Following the Protocol Defined Hereinbefore.

The following constituents were used:
Carrier: Cetiol® OE, Centiol® Sensoft, Agnique® AMD 10.
Monomers: MMA (methyl methacrylate; examples of a hydrophobic monomer); VME (vinyl mercaptoethanol; example of a monomer having at least one functional group).
Crosslinker: BDDA (1,4-butandediol diacrylate), DVB (divinyl benzene), MAA (methacrylic acid anhydride).
Corrosion inhibitors: benzothiazole, benzotriazole, quercetin.

Agnique® AMD 10 is N,N-dimethyldecan-1-amide having a boiling point of 291° C. (1,013 hPa). Cetiol® OE is a dicaprylyl ether having a boiling point of 292° C. Cetiol® Sensoft is the 2-propylheptylester of octanoic acid and has a boiling point of 319° C. Benzothiazole has a solubility in water of about 4.3 mg/mL at 23° C. Benzotriazole has a solubility in water of about 20 mg/mL at 23° C. Quercetin is essentially insoluble in water at 23° C.

The following capsules were prepared in this manner according to the general preparation protocol:

### Example E1

Capsule shell prepared from MMA and from BDDA as crosslinker utilized in a 4:1 wt.-% ratio. The core was composed of a 3:1 wt.-%-mixture of benzothiazole as corrosion inhibitor and Cetiol® OE as carrier. The targeted core-shell ratio was 85/15 wt.-%. E1 has a solid content of 23.8 wt.-%. The “targeted active content”, which is the content of corrosion inhibitor in the emulsion, was 19.8 wt.-%.

### Example E2

Capsule shell prepared from MMA and from BDDA as crosslinker utilized in a 4:1 wt.-% ratio. The core was composed of a 3:1 wt.-%-mixture of benzothiazole as corrosion inhibitor and Cetiol® Sensoft as carrier. The targeted core-shell ratio was 75/25 wt.-%. E2 has a solid content of 19.8 wt.-%. The “targeted active content” was 17.2 wt.-%.

### Example E3

Capsule shell prepared from MMA and from BDDA as crosslinker utilized in a 7:3 wt.-% ratio. The core was composed of a 3:1 wt.-%-mixture of benzothiazole as corrosion inhibitor and Cetiol® Sensoft as carrier. The targeted core-shell ratio was 80/20 wt.-%. E3 has a solid content of 15.8 wt.-%. The “targeted active content” was 18.4 wt.-%.

### Example E4

Capsule shell prepared from MMA and from BDDA as crosslinker utilized in a 4:1 wt.-% ratio. The core was composed of a 1:1 wt.-%-mixture of benzothiazole as corrosion inhibitor and Cetiol® Sensoft as carrier. The targeted core-shell ratio was 80/20 wt.-%. E4 has a solid content of 26.4 wt.-%. The “targeted active content” was 11.9 wt.-%.

### Example E5

Capsule shell prepared from MMA and from BDDA as crosslinker utilized in a 3:2 wt.-% ratio. The core was composed of a 3:1 wt.-%-mixture weight ratio of benzothiazole as corrosion inhibitor and Cetiol® Sensoft as carrier. The targeted core-shell ratio was 80/20 wt.-%. E5 has a solid content of 9.9 wt.-%. The “targeted active content” was 18.3 wt.-%.

### Example E6

Capsule shell prepared from MMA, VME and from BDDA as crosslinker utilized in a 5:1:4 wt.-% ratio. The core was composed of a 3:1 wt.-%-mixture of benzothiazole as corrosion inhibitor and Cetiol® Sensoft as carrier. The targeted core-shell ratio was 80/20 wt.-%. E6 has a solid content of 18.1 wt.-%. The “targeted active content” was 18.3 wt.-%.

### Example E7

Capsule shell prepared from MMA and MAA as crosslinker utilized in a 3:2 wt.-% ratio. The core was composed of a 3:1 wt.-%-mixture of benzothiazole as corrosion inhibitor and Cetiol® Sensoft as carrier. The targeted core-shell ratio was 80/20 wt.-%. E7 has a solid content of 9.2 wt.-%. The “targeted active content” was 18.3 wt.-%.

### Example E8

Capsule shell prepared from MMA and from BDDA as crosslinker utilized in a 85:15 wt.-% ratio. The core was composed of a 1:1 wt.-%-mixture of 1,2,3-benzotriazole as corrosion inhibitor and Agnique® AMD 10 as carrier. The targeted core-shell ratio was 80/20 wt.-%. E8 has a solid content of 24.1 wt.-%. The “targeted active content” was 12.7 wt.-%.

### Example E9

Capsule shell prepared from MMA and from MAA as crosslinker utilized in a 3:2 wt.-% ratio. The core was composed of a 3:1 wt.-%-mixture of quercetin as corrosion inhibitor and Agnique® AMD 10 as carrier. The targeted core-shell ratio was 80/20 wt.-%. E9 has a solid content of 9.2 wt.-%. The “targeted active content” was 8.3 wt.-%.

### 1.3 Properties of the Capsules

Average particle size diameters for examples E1 to E9 were determined according to the method disclosed hereinbefore. The values determined are summarized in Table 1.

TABLE 1

| Encapsulation structure of | d50 | d90 |
|---|---|---|
| example | [μm] | [μm] |
| E1 | 1.0 | 1.7 |
| E2 | 0.9 | 1.5 |
| E3 | 0.9 | 1.5 |
| E4 | 1.2 | 1.9 |
| E5 | 0.8 | 1.4 |
| E6 | 0.9 | 1.4 |
| E7 | 1.0 | 1.6 |
| E8 | 1.3 | 2.4 |
| E9 | 1.0 | 1.5 |

2. Preparation of Aqueous Coating Compositions Suitable for Providing Permanent coatings
2.1 the Following Constituents were Used Besides Water for Preparing the Compositions:
Additive 1: commercially available silicone surfactant.
Additive 2: commercially available defoamer.
Wax: commercially available cationic emulsion of an oxidized HD polyethylene wax (solid content: 30 wt.-%).
HGE: hydrophobic glycol ether (commercially available).
AR: commercially available (meth)acrylic resin dispersion having a solids content of 40.0 wt.-%.
PUR: commercially available aqueous aliphatic cationic polycarbonate-polyurethane dispersion having a solids content of 35.0 wt.-%.
Inorganic aqueous mixture (IAM): mixture comprising besides water inter alia an organosilane, and H₂TiF₆ and/or H₂ZrF₆.

### 2.2 General Preparation Protocol

An aqueous polymer dispersion was prepared from water, additives 1 and 2, a mixture of AR and PUR, a mixture of wax, HGE and IAM, as well as one of the capsules E1 to E7 and E9. A reference composition RE not containing a capsule has also been prepared in this manner

2.3 A number of acidic aqueous coating compositions PC1 to PC8 has been prepared following the protocol as set out hereinbefore, each of them having a pH value in a range of from 3.0 to 4.0. The compositions are summarized in Table 2. All amounts given are given in pbw. All compositions had a VOC-content of 0 wt.-%.

2.4 The storage stability of all composition PC1 to PC8 and RE was very good after 1 day of storage at room temperature. The compositions PC1 to PC3, PC5, PC6, PC7 and RE have further been investigated as far as their storage stability after 15 days and after 30 days is concerned: in all cases an excellent storage stability was observed.

TABLE 2

| | | | | | | | | | RE |
|---|---|---|---|---|---|---|---|---|---|
| Constituent | PC1 | PC2 | PC3 | PC4 | PC5 | PC6 | PC7 | PC8 | (comparative) |
| Additive 2 | 0.2 | 0.2 | 0.2 | 0.2 | 0.2 | 0.2 | 0.2 | 0.2 | 0.2 |
| Mixture of | 20.5 | 20.5 | 20.5 | 20.5 | 20.5 | 20.5 | 20.5 | 20.5 | 20.5 |
| wax, HGE | | | | | | | | | |
| and IAM | | | | | | | | | |
| Deionized | 2.1 | 1.8 | 2.0 | 1.0 | 1.9 | 1.9 | 1.9 | 1.9 | 3.7 |
| water | | | | | | | | | |
| Mixture of | 23.5 | 23.5 | 23.5 | 23.5 | 23.5 | 23.5 | 23.5 | 23.5 | 23.5 |
| AR and PUR | | | | | | | | | |
| Capsule | 3.6 (E1) | 4.0 (E2) | 3.7 (E3) | 4.7 (E4) | 3.8 (E5) | 3.8 (E6) | 3.8(E7) | 3.8 (E9) | — |
| Additive 1 | 0.1 | 0.1 | 0.1 | 0.1 | 0.1 | 0.1 | 0.1 | 0.1 | 0.1 |
| Solid content | 28.6 | 28.6 | 28.6 | 28.6 | 28.6 | 28.6 | 28.6 | 28.6 | 28.6 |
| [wt.-%] | | | | | | | | | |

3. Permanent Coatings Obtained from the Coating Compositions and Properties Thereof.

3.1 Each of the acidic aqueous coating compositions PC1 to PC8 as well as RE was applied to the surface of a panel made of galvanized steel (HDG) at room temperature (23° C.) using a blade doctor or roll coater. The coated substrates were then dried at a peak metal temperature of 60° C. (oven temperature 210° C.) for about 10 s. The resulting permanent coatings had a dry layer film thickness of about 1.2 μm as measured by XRF using a tracer element. The coating weights were in a range of from 1.1 to 1.2 g/m². The coated substrates obtained from PC1 to PC7 as well as RE have been subjected to a NSS test and to a wet stack (WS) test, both as described in the ‘methods’ section. The results are displayed in Table 3.

TABLE 3

| Substrate coated with | | |
|---|---|---|
| permanent coating on | NSS test | WS test |
| HDG | (120 h and 240 h) | (504 h) |
| PC1 | 0-1 | 2 |
| PC2 | 2 | 2 |
| PC3 | 0-1 | 2 |
| PC4 | 0-1 | 2 |
| PC5 | 2 | 0-1 |
| PC6 | 0-1 | 2 |
| PC7 | 0-1 | 0-1 |
| RE | 4-5 | 4-5 |

3.2 Each of the resulting coated panels obtained as outlined in item 3.1 was further coated with a powder coating composition (commercial product Interpon® 771) applied on top of the permanent coatings. A crosscut test before or after a condensation climate test as described in the ‘methods’ section was subsequently performed. The results are displayed in Table 4.

TABLE 4

| Substrate coated with | Crosscut before 240 h of | Crosscut after 240 h of |
|---|---|---|
| permanent coating | climate condensation test | climate condensation test |
| PC1 | 0-1 | 0-1 |
| PC2 | 0-1 | 0-1 |
| PC3 | 0-1 | 0-1 |
| PC4 | 0-1 | 0-1 |
| PC5 | 0-1 | 0-1 |
| PC6 | 0-1 | 0-1 |
| PC7 | 0-1 | 0-1 |
| PC8 | 0-1 | 0-1 |
| RE | 0-1 | 0-1 |

3.3 Each of the acidic aqueous coating compositions PC1 to PC7 as well as RE was applied to the surface of a panel made of Galvalume (aluminum-rich galvanized steel) at room temperature (23° C.) using a blade doctor or roll coater. The coated substrates were then dried at a peak metal temperature of 60° C. (oven temperature 210° C.) for about 10 s. The resulting permanent coatings had a dry layer film thickness of about 1.2 μm as measured by XRF using a tracer element. The coating weights were in a range of from 1.1 to 1.2 g/m². The coated substrates have been subjected to a NSS test and to a wet stack (WS) test, both as described in the ‘methods’ section. The results are displayed in Table 5. No darkening or dark spots were observed.

TABLE 5

| Substrate coated with | | |
|---|---|---|
| permanent coating on | NSS test | WS test |
| Galvalume | (120 h and 240 h) | (504 h) |
| PC1 | 0-1 | 1 |
| PC2 | 0-2 | 0 |
| PC3 | 0-1 | 0 |
| PC4 | 0-2 | 1 |
| PC5 | 0-1 | 0 |
| PC6 | 0-0 | 0 |
| PC7 | 0-1 | 0 |
| RE | 0-3 | 3 |

1. An aqueous coating composition comprising besides water
at least one film-forming polymer,
at least one metal ion selected from the group of titanium, zirconium and hafnium ions, and mixtures thereof, and
at least one encapsulation structure comprising a polymeric shell and a core within the shell, wherein
the shell is obtained from polymerization of at least one (meth)acrylic monomer or from a monomer mixture comprising the at least one (meth)acrylic monomer, in the presence of the core, and
the core comprises at least one corrosion inhibiting constituent, said constituent having in its non-encapsulated state a water solubility at 23° C. of less than 50 g/L, wherein the core optionally further comprises at least one non-aqueous solvent.

2. The aqueous coating composition according to claim 1, wherein the at least one corrosion inhibiting constituent present in the core of the encapsulation structure has in its non-encapsulated state a water solubility at 23° C. of less than 40 g/L.

3. The aqueous coating composition according to claim 1, wherein the corrosion inhibiting constituent present in the core of the encapsulation structure is an inorganic or organic constituent.

4. The aqueous coating composition according to claim 1, wherein the encapsulation structure has an average median d50 particle size diameter in a range of from 0.1 to 30 μm, and/or the amount of the shell is in a range of from 1 to 70 wt.-%, based on the total weight of the encapsulation structure comprising shell and core.

5. The aqueous coating composition according to claim 1, wherein the at least one non-aqueous solvent optionally present in the core of the encapsulation structure has a boiling point at atmospheric pressure of >100° C., and/or it has in its non-encapsulated state a water miscibility at 23° C. of less than 5 g/L.

6. The aqueous coating composition according to claim 1, wherein the shell of the encapsulation structure is obtained from at least one (meth)acrylic monomer m1, from at least one monomer m2, from a monomer mixture comprising the at least one (meth)acrylic monomer m1 and optionally at least one further monomer m2 and/or optionally at least one further monomer m3, or from a monomer mixture comprising the at least one monomer m2 and optionally at least one further monomer m1 and/or optionally at least one further monomer m3, both m2 and m3 being different from one another and from monomer m1,
wherein the at least one (meth)acrylic monomer m1 is a non-functionalized (meth)acrylic monomer, wherein monomer m2 being optionally present in the monomer mixture is a monomer having at least one ethylenically unsaturated group and further bearing at least one functional group, and
wherein monomer m3 being optionally present in the monomer mixture is a monomer having at least two ethylenically unsaturated groups.

7. The aqueous coating composition according to claim 1, wherein the encapsulation structure present therein is obtained by a method comprising at least steps a) and b),
a) providing a mixture of (i) the at least one (meth)acrylic monomer or of the monomer mixture comprising the at least one (meth)acrylic monomer suitable for formation of the polymeric shell of the encapsulation structure, (ii) the at least one corrosion inhibiting constituent suitable for formation of the core of the encapsulation structure, wherein the corrosion inhibiting constituent can be optionally present in a mixture further comprising at least one non-aqueous solvent, said mixture being suitable for forming an oil phase, and then emulsify into (iii) water as aqueous continuous phase, wherein optionally at least one emulsifier and/or surfactant is present in the aqueous continuous phase (iii) and/or in the mixture formed from (i) and (ii), and
b) polymerizing the at least one (meth)acrylic monomer or the monomer mixture comprising the at least one (meth)acrylic monomer to form the shell of the encapsulation structure comprising as a core within the shell formed upon polymerization the at least one corrosion inhibiting constituent, wherein the core may optionally further comprise at least a part of the at least one non-aqueous solvent.

8. The aqueous coating composition according to claim 1, wherein the at least one metal ion selected from the group consisting of titanium, zirconium and hafnium ions, and mixtures thereof, is present or used at least in the form of its/their complex fluoride(s) when the aqueous coating composition is acidic or is present or used at least in the form of its/their carbonates and/or lactates, when the composition is alkaline.

9. The aqueous coating composition according to claim 1, wherein it has
a pH value in a range of from 0.1 to <7.0,
or has
a pH value in a range of from ≥7.0 to 14.0.

10. The aqueous coating composition according claim 1, wherein it contains the at least one encapsulation structure in an amount in a range of from 0.1 to 20 wt.-% based on the total weight of the aqueous coating composition.

11. The aqueous coating composition according to claim 1, wherein it comprises at least two film-forming polymers being different from one another.

12. A method of using the aqueous coating composition according to claim 1, the method comprising using the aqueous coating composition for corrosion protection of metallic substrates.

13. A method for treatment of at least one surface of an optionally pre-coated metallic substrate comprising at least step 1) and optionally also step 2),
1) applying the aqueous coating composition according to claim 1 at least in portion onto the at least one surface of the metallic substrate to form a coating film at least in portion on said surface, and
2) optionally curing or drying the coating film obtained after step 1) to give a cured or dried coating layer.

14. The method for treatment according to claim 13, wherein the metallic substrate is a substrate made at least partially of steel, galvanized steel, steel alloys, aluminum, aluminum alloys, zinc, zinc alloys, and mixtures thereof.

15. A metallic substrate comprising at least one surface, wherein said at least one surface has been treated according to the method of claim 13.

16. The aqueous coating composition according to claim 1, wherein the at least one corrosion inhibiting constituent present in the core of the encapsulation structure has in its non-encapsulated state a water solubility at 23° C. of less than 30 g/L.

17. The aqueous coating composition according to claim 1, wherein the corrosion inhibiting constituent present in the core of the encapsulation structure is an organic compound having at least one cycloaliphatic, heterocycloaliphatic, aromatic and/or heteroaromatic moiety.

18. The aqueous coating composition according to claim 1, wherein the encapsulation structure has an average median d50 particle size diameter in a range of from 0.2 to 20 μm, and/or the amount of the shell is in a range of from 2 to 65 wt.-%, based on the total weight of the encapsulation structure comprising shell and core.

19. The aqueous coating composition according to claim 1, wherein the at least one non-aqueous solvent present in the core of the encapsulation structure has a boiling point at atmospheric pressure of >125° C. and/or it has in its non-encapsulated state a water miscibility at 23° C. of less than 2.5 g/L.

20. The aqueous coating composition according to claim 6, wherein the shell of the encapsulation structure
contains only monomeric units mu1 derived from the at least one (meth)acrylic monomer m1 and no other monomeric units besides monomeric units m1,
or contains monomeric units mu1 derived from the at least one (meth)acrylic monomer m1 in an amount in a range of from 60 to 99 wt.-%, and monomeric units mu2 derived from the at least one monomer m2 in an amount in a range of from 1 to 40 wt.-%,
or contains monomeric units mu1 derived from the at least one (meth)acrylic monomer m1 in an amount in a range of from 40 to 99 wt.-%, and monomeric units mu3 derived from the at least one monomer m3 in an amount in a range of from 1 to 50 wt.-%,
or contains monomeric units mu1 derived from the at least one (meth)acrylic monomer m1 in an amount in a range of from 30 to 98 wt.-%, monomeric units mu2 derived from the at least one monomer m2 in an amount in a range of from 1 to 35 wt.-%, and monomeric units mu3 derived from the at least one monomer m3 in an amount in a range of from 1 to 50 wt.-%,
wherein the sum of all monomers used for preparing the shell of the encapsulation structure, adds up to 100 wt.-% in each case.
